(19) United States
(12) Patent Application Publication
(10) Pub. No.: US 2010/0005113 A1
(43) Pub. Date: Jan. 7, 2010

(54) FUNCTION IN A RELATIONAL DATABASE

(75) Inventors: Teng Hu, Austin, TX (US); Hung T. Dinh, Austin, TX (US); Phong A. Pham, Austin, TX (US); David P. Lee, Roundrock, TX (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/166,502

(22) Filed: Jul. 2, 2008

(51) Int. Cl. G06F 17/30

(52) U.S. Cl. 707/101; 707/E17.005

(57) ABSTRACT

A method of retrieval and presentation of data in denormalized format may include accessing a relational database of CHARACTER or VARCHAR data types in normal form, applying a database command SUMTEXT(column name, delimiter string) to the relational database, retrieving related sets of text strings from the relational database, truncating leading blanks and trailing blanks in each string, limiting the length of each string to a predetermined value, appending related strings using a delimiter string specified, and presenting denormalized data strings.

### TECHNICAL FIELD

The present disclosure generally relates to the field of database management and more particularly to a technique for manipulating data from a database and discerning the data in a particular format.

### BACKGROUND

Data are usually stored as 3^{rd} normal form in a relational database. This makes it difficult for an application that needs to present the data in a denormalized format. For example, an application might want to display the purchased product codes for the same customer on a single line.

The database table, PURCHASE_INFO, contains the following records.

PURCHASE_INFO

| CUSTOMER_ID | PRODUCT_CD |
|---|---|
| 1 | A123 |
| 1 | B124 |
| 1 | C125 |
| 2 | A123 |
| 2 | B234 |

In order to show the result as a single row for each customer, users are required to write a recursive SQL. For example,

-- x table is the parent table, x will have rownum=1,2,3...
WITH
x (customer_id, product_cd, rownum) AS
(SELECT customer_id, product_cd,
row_number( ) over(partition by customer_id) rownum
FROM PURCHASE_INFO ORDER BY CUSTOMER_ID,
PRODUCT_CD),
-- y is the child table.
y (customer_id, product_cd, cnt, cntmax) AS
(
-- get a unique row with the max row number. Initialize product_cd to
null
(SELECT customer_id, cast(″ as varchar(400)) product_cd, 0,
max(rownum)
FROM x
GROUP BY customer_id)
UNION ALL
SELECT x.customer_id,
case when y.product_cd=″ then x.product_cd
else y.product_cd ||‘,’|| x.product_cd end,
y.cnt+1, y.cntmax
FROM x, y
WHERE x.customer_id = y.customer_id
and x.rownum=y.cnt+1
and y.cnt<y.cntmax
)
SELECT customer_id, product_cd
FROM y
WHERE
y.cnt=y.cntmax
order by customer_id
;

Here is the result of the above SQL.

| CUSTOMER_ID | PRODUCT_CD |
|---|---|
| 1 | A123, B124, C125 |
| 2 | A123, B234 |

As can be seen, the above SQL is unreadable and hard to maintain.

### SUMMARY

A method of retrieval and presentation of data in denormalized format including, but not limited to, accessing a relational database of CHARACTER or VARCHAR data types in normal form, applying a database command SUMTEXT(column name, delimiter string) to said relational database, retrieving related sets of text strings from said relational database, truncating leading blanks and trailing blanks in each string, limiting the length of each string to a predetermined value, appending related strings using a delimiter string specified, and presenting denormalized data strings.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for the use of the SUMTEXT function in a relational database.

### DETAILED DESCRIPTION

Reference will now be made in detail to the subject matter disclosed, which is illustrated in the accompanying drawings.

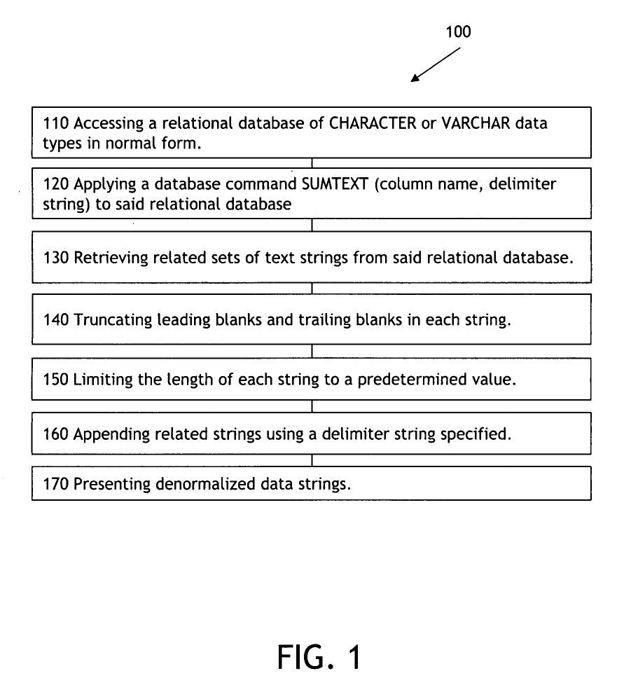

The present disclosure is directed to preventing data retrieval difficulty. Referring to FIG. 1, a flow diagram illustrating a method 100 for the use of the SUMTEXT function in a relational database. A method 100 of retrieval and presentation of data in denormalized format may include accessing a relational database of CHARACTER or VARCHAR data types in normal form 110, applying a database command SUMTEXT(column name, delimiter string) to the relational database 120, retrieving related sets of text strings from the relational database 130, truncating leading and trailing blanks in each string 140, limiting the length of each string to a predetermined value 150, appending related strings using a delimiter string specified 160, and presenting denormalized data strings 170.

To solve the issue of data retrieval difficulty, a method to access a relational database may provide a new function such as SUMTEXT(column name, delimiter string) that is applied to CHARACTER and VARCHAR data types. This method may remove all leading and trailing blanks before appending, may append the text for the specified column together and may be written as follows:
SELECT customer_id, SUMTEXT(product_cd ‘,’) product_cds FROM purchase_info group by customer_id;

When the method of use of the SUMTEXT function is specified, the database engine may append the text of the specified column together using the delimiter string specified. Similar to the SUM function in a numerical application, SUMTEXT supports text data. Also, the method of use of the SUMTEXT function will have a predefined maximum length where the presented data will be truncated at this maximum length.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method of retrieval and presentation of text data in denormalized format comprising:
accessing a relational database of CHARACTER or VARCHAR data types in normal form;
applying a database command SUMTEXT(column name, delimiter string) to said relational database;
retrieving related sets of text strings from said relational database;
truncating leading blanks and trailing blanks in each string;
limiting the length of each string to a predetermined value;
appending related strings using a delimiter string specified; and
presenting denormalized data string, wherein said presented data string is truncated at a predefined maximum length.
